(19) United States
(12) Patent Application Publication
(10) Pub. No.: US 2015/0124097 A1
(43) Pub. Date: May 7, 2015

(54) OPTICAL REPRODUCTION AND DETECTION SYSTEM IN A VEHICLE

(71) Applicant: Robert Bosch GmbH, Stuttgart (DE)

(72) Inventors: Alexander MUELLER, Bietigheim (DE); Philippe DREUW, Heersum (DE)

(21) Appl. No.: 14/534,879

(22) Filed: Nov. 6, 2014

(30) Foreign Application Priority Data
Nov. 7, 2013 (DE) 10 2013 222 584.9

(51) Int. Cl. B60R 1/00; B60R 1/12

(52) U.S. Cl. CPC B60R 1/00; B60R 1/12; B60R 2001/1253; B60R 2300/102; B60R 2300/205; B60R 2300/8026; B60R 2300/8006
USPC 348/148

(57) ABSTRACT

An optical reproduction and detection system in a vehicle includes a surroundings recording device, a representation device as well as a view detection device. The representation of the recorded vehicle surroundings takes place as a function of the detected direction of view of the driver.

### RELATED APPLICATION INFORMATION

The present application claims priority to and the benefit of German patent application no. 10 2013 222 584.9, which was filed in Germany on Nov. 7, 2013, the disclosure of which is incorporated herein by reference.

### FIELD OF THE INVENTION

The present invention relates to an optical reproduction and detection system in a vehicle.

BACKGROUND INFORMATION

A detection system is discussed in German document DE 10 2011 084 552 A1 for detecting the state of alertness of the driver of a motor vehicle. The system includes a camera integrated into a mobile device, which takes the eyes of the driver, the images taken being examined for typical patterns, which give an insight into the state of alertness of the driver. The eyelid closing activity and the iris activity, from which critical drowsiness is able to be detected, are monitored. If the detected drowsiness exceeds a boundary value, a warning is output.

European document EP 1 732 028 B1 discusses a method for detecting the eyes of a driver in a vehicle, in which the face of the driver is taken by a video image camera and the image taken is examined for typical feature patterns.

### SUMMARY OF THE INVENTION

The present invention is based on the object of increasing the travel safety in vehicles.

According to the present invention, this objective is attained by the features described herein. The further description herein describe expedient refinements.

The optical reproduction and detection system according to the present invention may be integrated into vehicles, in particular, motor vehicles and is used to provide data for the driver on the surroundings of the vehicle while unloading the driver at the same time and preventing an information overload. In the reproduction and detection system according to the present invention, the data are able to be made available to the driver in a targeted manner.

The reproduction and detection system includes various components, among which are a surroundings recording device, a representation device and a view detection device. The vehicle surroundings are able to be recorded by the surroundings recording device, such as braking vehicles, traffic signs, pedestrians, roadway boundaries, obstacles, etc. With the aid of the representation device which is present in the vehicle, and which is a part of the reproduction and detection system, the recorded vehicle surroundings are able to be represented on an imaging surface, so that the recorded surroundings are provided as information to the driver on the imaging surface. The imaging surface is advantageously located in the field of view of the vehicle. The direction of view of the driver is able to be detected with the aid of the view detection device. For this purpose, the posture of the head and/or the positioning and motion of the eyes of the driver may be taken and evaluated.

In an evaluation unit of the reproduction and detection system, the data from the detected direction of view of the driver and surroundings recording device are brought together. In the reproduction and detection system according to the present invention, the representation of the recorded vehicle surroundings is a function of the detected direction of view of the driver. Consequently, there takes place a linkage of the information presented to the driver on the imaging surface in the vehicle with the direction of view of the driver, so that the driver is able to control the information represented via his direction of view. While only specific data are reproduced as a function of the direction of view, all-in-all, the quantity of data represented is substantially reduced, which leads to an unloading of the driver and an improvement of the travel safety.

According to one advantageous embodiment, the representation of the recorded vehicle surroundings takes place on the imaging surface only in the case in which the driver is actually looking at the imaging surface. On the other hand, if the view of the driver is not directed at the imaging surface, no data are shown on the latter. This has the advantage that the driver is not distracted by data that were not requested by him. The representation of data on an imaging surface is able to distract the driver, even when his view is not directed directly onto the imaging surface; this distraction is avoided in the embodiment according to the present invention, in which the system avoids the representation if the driver is not looking at the imaging surface.

The driver may also have an influence in other ways on the representation of the data, taken from the vehicle surroundings. If necessary, one is able to draw a conclusion on the desired information content on the imaging surface, from a variation with time of the direction of the view. For instance, the wandering of the gaze over a certain angular segment is able to lead to a representation of the vehicle surroundings, within this angular segment, on the imaging surface. Furthermore, it is possible to play both single images and film sequences on the imaging surface, which are generated via the surroundings recording device. The individual images advantageously represent the current state of the vehicle surroundings, and are correspondingly updated continuously. However, it is also possible to show individual images as still images, which reflect the vehicle surroundings at a certain point in time.

The data shown may also depend on the type of the imaging surface. According to one advantageous embodiment, at least one imaging surface is configured as an internal or external mirror which is used to observe the surroundings located behind the vehicle. If the driver directs his view towards the internal or external mirror, then, in the mirror which forms the imaging surface, the information taken via the surroundings recording device from the backward vehicle region is shown in the mirror.

A plurality of imaging surfaces may be present in the vehicle, which may be internal and/or external rearview mirrors and a monitor in the vehicle. Furthermore, it is possible to provide one or more projection systems (head-up displays) in the vehicle, using which, for example, an image may be projected onto a vehicle window pane, if necessary, having a focal point lying behind the vehicle window pane. In this connection, basically all vehicle window panes come into consideration, that is, besides the windshield and the rear windshield, also the side windows. In particular, the driver's surroundings present in the respective direction of view are shown via the projection system of the window pane lying in the direction of view. Consequently, in response to the look of the driver at the rear windshield during parking, via a camera system as surroundings recording device, the rear section of the vehicle may be shown. According to a further application, for example, via a night vision unit as the surroundings recording device, the vehicle surroundings may be projected into a vehicle window pane at night.

As long as the representation system in the vehicle includes one or more mirrors, the mirror surface, which forms the imaging surface, is advantageously executed as a monitor which is able to be actuated digitally to the desired representation of the vehicle surroundings.

Various embodiments of surroundings recording devices come into consideration, such as a surroundings camera, for taking the surroundings in the visible range, but also radar and infrared systems to record objects present at a greater distance away, such as third cars or detecting persons by night who are spending time in the vehicle surroundings.

As a view detection device, camera systems come into consideration which are directed at the head of the driver. The camera system may perhaps be configured as an infrared-sensitive camera, particularly as an LED camera, which radiates a weak infrared light which leads to a reflection in the eyes or rather the cornea of the driver, that is taken by the camera. This makes it possible, in the image, to identify the pupils in the eye which appear as black disks having a colored outer ring and being framed by the white eyeball as well as the upper and lower eyelid. With this information, it is possible to determine the direction of view of the driver. If necessary, one may draw a conclusion on what the direction of view is from the posture of the head of the driver which may also be determined via a camera system as the view detection device.

The various steps for evaluating and generating control signals run in an arithmetic unit, which may be a component of an closed-loop or open loop control unit, that is associated with the reproduction and detection system. In the arithmetic and evaluation unit, the various devices of the reproduction and detection system are actuated and data, especially measuring signals, are processed. In particular, the measuring signals of the surroundings recording device as well as the view detection device are evaluated and a control signal is generated for the representation device. If necessary, the data from the surroundings recording device may be changed, such as by compression, in order to adapt the image shown on the imaging surface. This makes it possible during night travel, for example, to display persons from the vehicle surroundings, who are detected via the surroundings recording device, as pictograms or the like on the imaging surface.

Further advantages and expedient embodiments may be gathered from the additional claims, the description of the figures and the drawings.

### BRIEF DESCRIPTION OF THE DRAWINGS

FIG. 1 shows a schematic representation of a reproduction and detection system in a vehicle.

FIG. 2 shows the passenger compartment of a motor vehicle in a perspective view.

FIG. 3 shows a schematic representation of an infrared-sensitive LED camera for the detection of the facial region of the driver.

### DETAILED DESCRIPTION

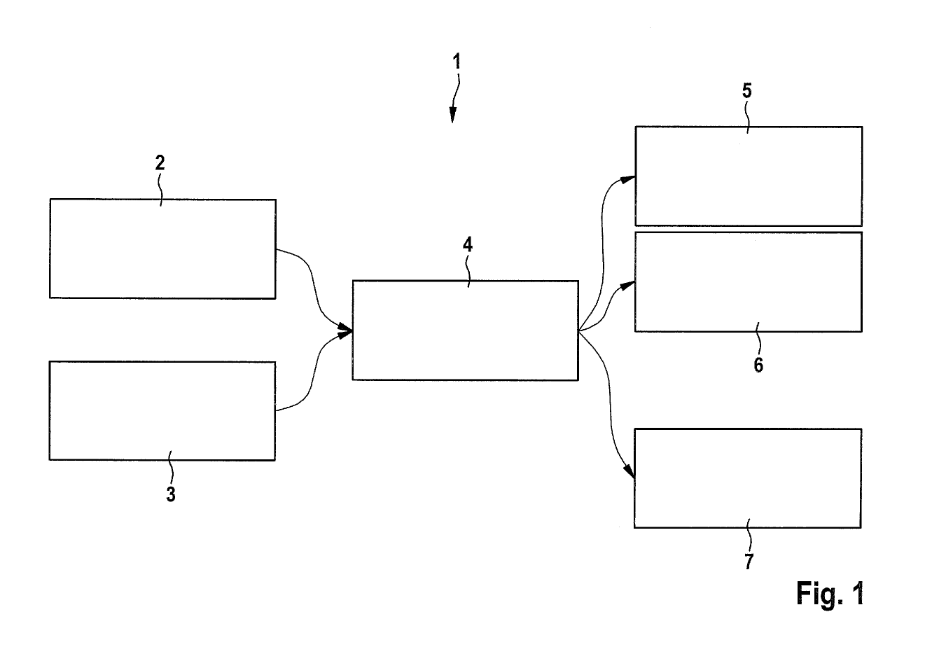

FIG. 1 shows a reproduction and detection system 1, which is incorporated in a vehicle and, using which, the vehicle surroundings are able to be observed and recorded, the direction of view of the driver is able to be detected and the vehicle surroundings shown as a function of the detected direction of view in the vehicle. Reproduction and detection system 1 includes a surroundings recording device 2 and a view detection device 3. The signals picked up by surroundings recording device 2 and view detection device 3 are supplied to an arithmetic and evaluation unit 4, in which the data are evaluated and output signals are generated for actuating representation devices 5, 6 and 7. Surroundings recording device 2 is a camera-based system, for example, a radar system and/or an infrared system. The vehicle surroundings are able to be taken by surroundings recording device 2, especially in all directions, if necessary, both a take in the visible and in the infrared range coming into consideration. Farther distant objects may be detected via the radar system.

The direction of view of the driver is detected with the aid of view detection device 3. View detection device 3 includes, for instance, an infrared-sensitive LED camera, which is directed at the head of the driver and emits a weak infrared signal via the LED's, which is reflected by the eye of the driver. Thereby it is possible to ascertain the direction of view of the driver.

If necessary, view detection device 3 may also determine the posture of the head of the driver, and gather additional information on the direction of view from the posture of the head. It is particularly possible to detect the head of the driver turned backwards in response to reverse travel.

In arithmetic and evaluation unit 4, the data are evaluated, and a valuation takes place according to a stored evaluation instruction. For example, a representation on a representation device 5, 6, 7 takes place only in case the evaluation in unit 4 yields that the view of the driver is directed at one of the representation devices. In this case, only the respective representation device 5, 6, 7 is actuated and only on it is the image corresponding to the direction of view and the functionality of the representation device shown. For instance, if the driver looks at the interior or the exterior rearview mirror, this is able to be determined via view detection device 3, whereupon the image ascertained from the surroundings recording device, which is directed towards the rear, is faded into the respective mirror. In this instance, the mirror may be executed as a monitor, which is able to be actuated electronically, or a corresponding image is projected via a projection system.

If the driver has, for instance, turned his head backwards and is looking in the direction of the rear windshield, then via a projection system executed as a head-up display, the rear region located directly at the vehicle may be projected into the rear windshield, in order to simplify backward parking.

In response to a look by the driver sideways to the left or right side window, via an additional projection system executed as a head-up display, the corresponding left or right vehicle surroundings region is able to be projected into the side window.

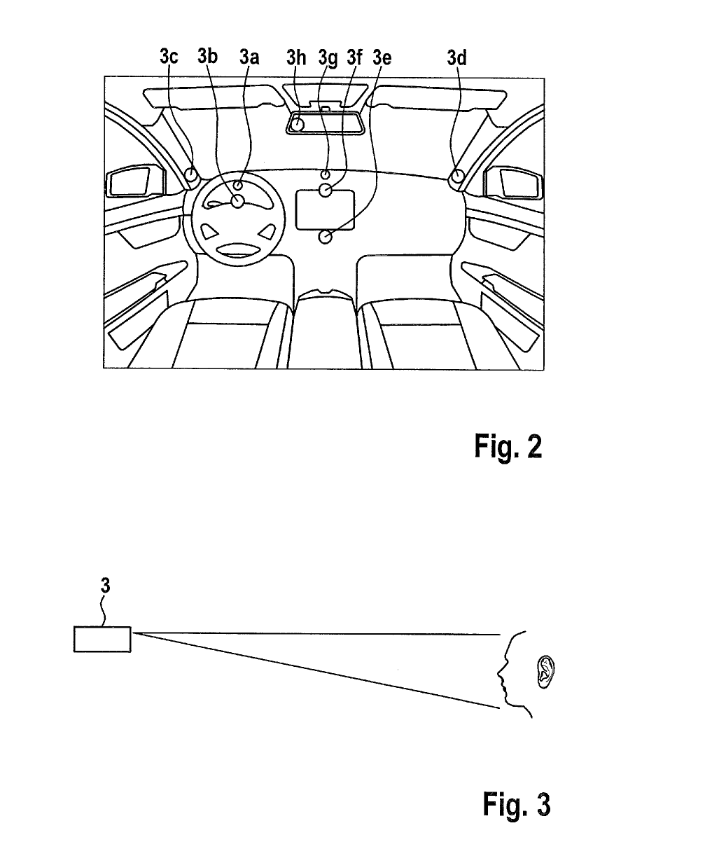

FIG. 2 shows the passenger compartment of a motor vehicle having view detection devices 3 at different positions. View detection device 3a is located in the dashboard area, directly below the steering wheel. View detection device 3b is located on the steering wheel, and view detection devices 3c and 3d are located in the left and right A-column, respectively. View detection devices 3e, 3f and 3g are located at different heights in the middle of the dashboard area. View detection device 3h is integrated into the internal rearview mirror.

It may be advantageous to provide a plurality of view detection devices in the passenger compartment, in order to be able to record the eyes of the driver in different postures of the head, and to be able to derive the direction of view from this.

View detection devices 3, as shown in FIG. 3, are aligned in such a way with respect to the head of the driver that the facial region is able to be recorded together with the eyes. Both the posture of the head and the direction of view of the eyes are able to be recorded via view detection device 3.

What is claimed is:

1. An optical reproduction and detection system in a vehicle, comprising:
a surroundings recording device to record the vehicle surroundings;
a representation device to represent the recorded vehicle surroundings on an imaging surface in the vehicle; and
a view detection device to detect the direction of view of the driver;
wherein the representation of the recorded vehicle surroundings occurs as a function of the detected direction of view of the driver.

2. The reproduction and detection system of claim 1, wherein the representation of the recorded vehicle surroundings occurs on the imaging surface only if the driver looks at the imaging surface.

3. The reproduction and detection system of claim 1, wherein the surroundings recording device includes a surroundings camera.

4. The reproduction and detection system of claim 1, wherein the representation device includes at least one monitor.

5. The reproduction and detection system of claim 4, wherein the monitor is integrated into a mirror in the vehicle.

6. The reproduction and detection system of claim 1, wherein the representation device includes at least one projection system, including a heads-up display.

7. The reproduction and detection system of claim 6, wherein the projection system, which includes a heads-up display, projects an image into a vehicle window pane.

8. The reproduction and detection system of claim 1, wherein the view detection device includes an infrared-sensitive LED camera.

9. The reproduction and detection system of claim 1, wherein the posture of the head of the driver is ascertained and the representation of the recorded vehicle surroundings takes place as a function of the detected posture of the head.

10. A method for operating an optical reproduction and detection system for a vehicle, the method comprising:
recording, via the optical reproduction and detection system, a direction of view of a driver and vehicle surroundings; and
displaying, via the optical reproduction and detection system, the vehicle surroundings as a function of the recorded direction of view in the vehicle;
wherein the optical reproduction and detection system includes a surroundings recording device to record the vehicle surroundings, a representation device to represent the recorded vehicle surroundings on an imaging surface in the vehicle, and a view detection device to detect the direction of view of the driver.
